(19) United States
(12) Patent Application Publication
(10) Pub. No.: US 2015/0332152 A1
(43) Pub. Date: Nov. 19, 2015

(54) Systems And Methods For Generating Models For Physical Systems Using Sentences In A Formal Grammar

(71) Applicant: Oren Goldschmidt, Laguna Niguel, CA (US)

(72) Inventor: Oren Goldschmidt, Laguna Niguel, CA (US)

(21) Appl. No.: 14/716,666

(22) Filed: May 19, 2015

Related U.S. Application Data
(60) Provisional application No. 62/000,113, filed on May 19, 2014.

(51) Int. Cl. G06N 5/04; G06F 17/27; G06N 99/00; G06F 17/28

(52) U.S. Cl. CPC G06N 5/04; G06F 17/28; G06F 17/274; G06N 99/005

(57) ABSTRACT

A human expert creates sentences in a formal grammar to describe the state of a physical system through aspects of the behavior of such systems. A software process combines these sentences with historical data about physical systems of the same type and uses machine learning to generate a model that detects this state in such systems. These models are able to detect important states of physical systems, such as states that are predictive of future failures, without needing precise guidance from a human user.

This application claims the benefit of priority to U.S. Provisional Application No. 62/000,113, filed May 19, 2014, the contents of which are incorporated by reference in their entireties. Where a definition or use of a term in a reference that is incorporated by reference is inconsistent or contrary to the definition of that term provided herein, the definition of that term provided herein is deemed to be controlling.

### FIELD OF THE INVENTION

The field of the invention is the creation of models for detecting the states of physical systems.

### BACKGROUND

The background description includes information that may be useful in understanding the present invention. It is not an admission that any of the information provided herein is prior art or relevant to the presently claimed invention, or that any publication specifically or implicitly referenced is prior art.

Physical systems including but not limited to industrial plant, power generation equipment, oil field equipment, and transportation systems, are prone to unexpected failure and inefficient operation. Such equipment is often provided with sensors which generate data that can be used to improve performance and predict impending failure.

Existing techniques for developing sophisticated models for these systems in order to predict failure far in advance and to optimize performance require extensive development effort either through the direct development of new algorithms or through the use of statistical modeling tools such as ‘SPSS’ or ‘SAS’. As such, existing methods are rarely used and cannot be deployed to deal with performance optimization and failure prediction where extensive development or modeling work is not cost effective or where resources for such work are in short supply.

A technique which allows human users familiar with the physical systems to build models using a more expressive paradigm would enable a significant reduction in the cost and effort required to build new models, allowing such models to be developed for the many classes of physical systems for which existing techniques have not been applied due to cost or resource constraints.

### SUMMARY OF THE INVENTION

The present invention provides apparatus, systems, and methods for detecting the state of a physical system through the novel application of language processing and machine learning.

The states to be detected may include states that arise in advance of a failure of the system to be monitored and hence are predictive of a failure. Such states, when detected by the system, can be used to alert users of the system to perform preventative maintenance, ensure replacement parts or systems are available, or change the operating parameters of the system to delay or prevent the failure.

The states to be detected may also include operating conditions that result in suboptimal efficiency of the system. In this case, detection of these states may be used to alert users of the system to alter the operating parameters of the system or take other action to ensure that the system is operating optimally.

Some aspects of the inventive subject matter provides for a technique, GAME (Grammar-Augmented Modeling Environment), for creating models for detecting the state of a physical system through the novel application of language processing and machine learning.

This technique allows human users to develop models for physical systems by interacting with a computer program in a familiar subset of a natural language (such as English, French, etc.) rather than requiring them to use a computer language (such as ‘R’) or to use a complex modeling tool (such as ‘SAS’ or ‘SPSS’). Furthermore, through the use of machine learning the present technique operates on indefinite instructions from the human user rather than requiring a precise definition of the properties of the final model.

In GAME, a formal grammar is used to describe a subset of the natural (human) language to be used for modeling. The formal grammar consists of a set of production rules that specify which sentences can be expressed by the user. This will consist of a small subset of all possible sentences in the natural language. The grammar allows users of GAME to build sentences interactively to describe patterns in the behavior of physical systems.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a design diagram for an exemplary implementation of a GAME model development and training system.

FIG. 2 is a design diagram for an exemplary implementation of a system that executes a GAME physical state detection model against live data.

FIG. 3 is a more detailed information flow chart showing an exemplary implementation of GAME machine learning and showing how in this implementation model sentences can be combined with historical data to generate a trained physical state detection model.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

The terms “configured to” and “programmed to” in the context of a processor refer to being programmed by a set of software instructions to perform a function or set of functions.

One should appreciate that the disclosed contacts directory discovery system provides numerous advantageous technical effects. For example, the contacts directory discovery system of some embodiments enables up-to-date contact information by methodically allowing the persons to update and edit contacts and contact information in shared directories.

The following discussion provides many example embodiments. Although each embodiment represents a single combination of components, this disclosure contemplates combinations of the disclosed components. Thus, for example, if one embodiment comprises components A, B, and C, and a second embodiment comprises components B and D, then the other remaining combinations of A, B, C, or D are included in this disclosure, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, numerical parameters expressing quantities are used. It is to be understood that such numerical parameters may not be exact, and are instead to be understood as being modified in some instances by the term “about.” Accordingly, in some embodiments, a numerical parameter is an approximation that can vary depending upon the desired properties sought to be obtained by a particular embodiment.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

Methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the described concepts and does not pose a limitation on the scope of the disclosure. No language in the specification should be construed as indicating any non-claimed essential component.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

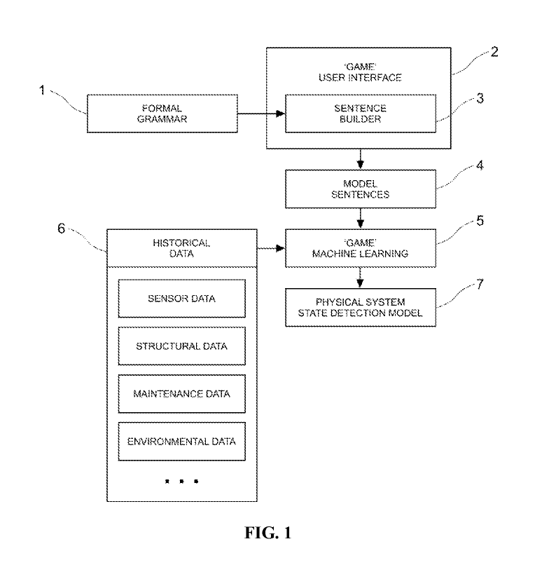

In FIG. 1, an expert can use the GAME user interface which incorporates the sentence builder of FIG. 1, 3. The sentence builder allows model sentences, 4, that match the rules of the formal grammar, 1, to be created interactively by the human user. The model sentences, 4, are represented as a list of tokens in the formal grammar. A single model may contain many model sentences, and model sentences may be used to describe relationships between different behaviors, as for example: ‘Pressure rises after temperature drops.’

The model sentences, 4, contain indefinite or vague descriptions of the state of a physical system. For example ‘Pressure dips repeatedly.’ GAME employs machine learning, 5, combined with historical data on the previous behavior of physical systems of the type being modeled, 6, to produce state detection models, 7, from such indefinite input sentences.

In processing the model sentences GAME produces a series of ‘preprocessing steps’ to be applied to one or more parts of the data available to the system concerning the behavior of the physical system. These steps may include Digital Signal Processing (DSP) and feature extraction.

This processing is done by producing a parse tree from the input sentences using recursive decent parsing or other parsing techniques. This parse tree may be reduced to an abstract syntax tree or similar structure or may be used without further processing.

GAME then processes the parse tree through a series of recursive reduction functions or otherwise to translate the parse tree into a specification of a preprocessing steps to be applied to sensor signals.

GAME applies the preprocessing steps to historical data about the behavior of physical systems of the type being modeled. The results of these preprocessing steps are combined with the historical data and applied to a machine learning process that generates a definite model from the indefinite model sentences.

The machine learning process may use techniques such as regression, support vector machines, or neural networks. In the machine learning process historical data, being sensor data from at least one historical case in which the state to be detected was known to be present, is fed through the preprocessing steps specified by the model sentences and the output of these preprocessing steps is fed to the machine learning algorithm as an input. This trains the machine learning algorithm to detect this state in future sensor data. The result of training the machine learning algorithm together with the preprocessing steps defined by the model sentences becomes the state detection model 7 of FIG. 1.

GAME may gather and employ additional information from the human user to guide the machine learning system. For example, GAME may collect information from the human user about time periods in existing historical data during which model sentences such as ‘Pressure drops repeatedly.’ held true. Such additional information may aid machine learning by specifying more precisely the time periods in the historical cases used for training in which certain patterns of data indicative of the state to be detected were present.

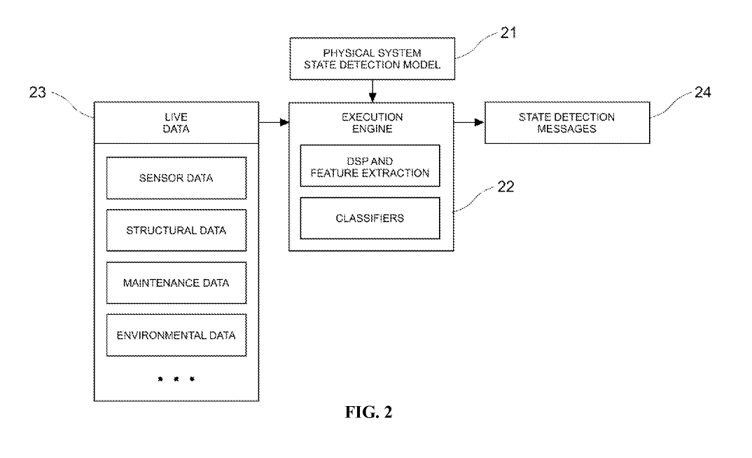

The state detection model 7 of FIG. 1 provides a series of parameters to be used with an execution engine, FIG. 2, 22. These parameters consist of the trained machine learning algorithm and the preprocessing steps defined by the model sentences.

In FIG. 2, the execution engine combines the model with data 21 concerning the physical system to be monitored to generate messages 24 when the model's target state is detected. The execution engine may apply the preprocessing steps derived from the model sentences which may include Digital Signal Processing (DSP) techniques to prepare the signals and feature extraction techniques to extract relevant features for further processing. One or more classifiers trained by machine learning (the trained machine learning algorithm) are then used to combine the historical data with the output of any preprocessing to classify the state of the physical system.

Model sentences created by a GAME interface as described in FIG. 1 or otherwise are the starting-point for a process which generates a trained physical system state detection model.

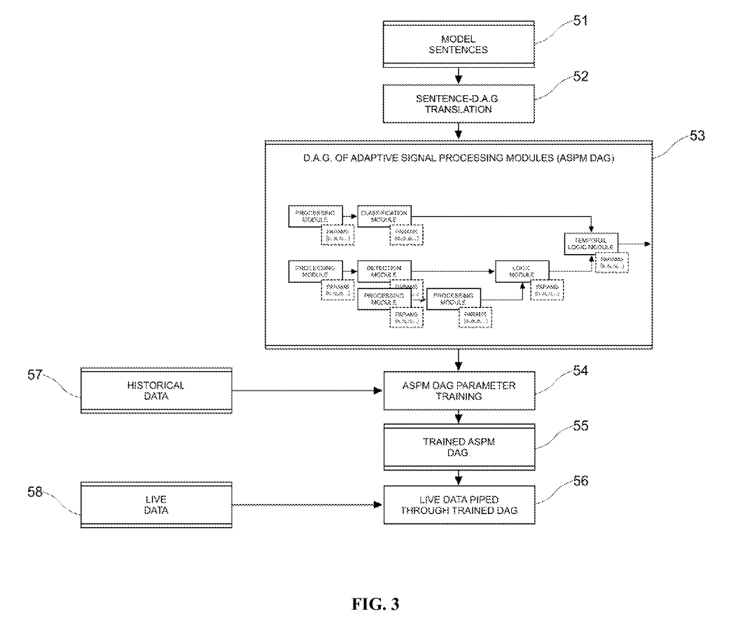

The sentences of the model are translated, with the help of the formal grammar, into a directed acyclic graph (DAG) representing how a set of connected signal processing modules may be connected to detect the state or condition being described by the model sentences, 52 and 53 of FIG. 3. This translation can be accomplished by a reduction of a parse tree or abstract syntax tree to a representation of a DAG of signal processing modules.

Each signal processing module processes one or more input signals to produce one or more outputs. Input signals may come from external data sources, such as machine sensor data, or from an output of another signal processing module. Each signal processing module has at least one output, but may have more than one.

The signal processing modules envisaged include, but are not limited to, digital signal processing functions on one or more input signal values with one or more outputs, logical functions that combine one or more inputs and perform a Boolean logic operation on them, temporal logic functions that evaluate the temporal relationship of one or more input signals over time, time-based aggregation functions such as windowed averages, and classification functions that classify their inputs into different groups. This would include operations such as simple transfer functions, mathematical operations on one or more signals such as addition, subtraction, and multiplication, and more complex operations such as filters and Fourier transforms.

In GAME, each signal processing module may contain one or more trainable parameters, represented by α1 to αn. While the general signal processing function delivered is determined by a choice of signal processing module, these trainable parameters significantly affect how the signal processing module operates on its input signals.

In the process of training a GAME model, 54 of FIG. 3, historical data is applied to the DAG of connected signal processing modules with tunable parameters (Adaptive Signal Processing Module DAG or ASPM DAG). The system operates in such a way as to adjust the parameters of each signal processing module in the ASPM DAG so that the overall DAG results in an output that matches the physical state of the system recorded as ground truth for the period for which historical data is being applied.

This process of parameter adjustment may be accomplished by a range of machine learning algorithms. In one embodiment, the parameters of the signal processing modules are adjusted by stochastic gradient descent to maximize the quality of the predictions of the overall ASPM DAG against the historical data being applied as training data.

Once the training process is complete, the ASPM DAG together with the estimated parameters of each signal processing module becomes the trained physical system state detection model.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for generating a model to detect a state of a physical system, comprising:
acquiring sensor data concerning the physical system;
utilizing a formal grammar to describe a subset of a natural human language relating to the behavior of at least one type of the physical system;
utilizing a person to create an expression in the formal grammar; and
utilizing an electronic processor to process the expression to generate a model that can be used to detect the state of the physical system.

2. The method of claim 1, wherein the formal grammar describes a technical language including technical terms, units of measure, and forms of expression.

3. The method of claim 1, wherein the sensor data comprises data generated other than through use of a sensor.

4. The method of claim 1, further comprising the processor receiving from the person an item of historical data in which a prior expression in the formal grammar holds true, and utilizes the historical data in generating the model.

5. The method of claim 1, wherein the formal grammar is parameterized according to terms derived from a database containing metadata about the physical system.

6. The method of claim 1, wherein the state is predictive of a future failure of the system.

7. The method of claim 1, wherein the state is characterized by an inefficient performance of the system.

8. The method of claim 1, further comprising generating the expression through an interactive GUI.
